(19) United States
(12) Patent Application Publication
(10) Pub. No.: US 2024/0086299 A1
(43) Pub. Date: Mar. 14, 2024

(54) DEVELOPMENT PLATFORM VALIDATION WITH SIMULATION

(71) Applicant: VMware, Inc., Palo Alto, CA (US)

(72) Inventors: Davinder Kumar, San Jose, CA (US); Jie Shang, Acton, MA (US)

(73) Assignee: VMware, Inc., Palo Alto, CA (US)

(21) Appl. No.: 18/244,101

(22) Filed: Sep. 8, 2023

Related U.S. Application Data
(60) Provisional application No. 63/405,177, filed on Sep. 9, 2022.

(51) Int. Cl. G06F 11/34; G06F 9/50

(52) U.S. Cl. CPC G06F 11/3457; G06F 9/5077

(57) ABSTRACT

The present disclosure relates to development platform validation with simulation. Some embodiments include instructions to recognize a simulation of a management system as an endpoint of a development platform in a virtualized environment, and execute performance testing on the development platform using the simulation.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for development platform validation with simulation according to one or more embodiments of the present disclosure.

FIG. 2 illustrates a system for development platform validation with simulation according to one or more embodiments of the present disclosure.

FIG. 3 is a diagram of a system for development platform validation with simulation according to one or more embodiments of the present disclosure.

FIG. 4 is a diagram of a machine for development platform validation with simulation according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

A development platform (e.g., vRealize Automation (vRA)) is designed to deliver a personalized, self-service experience on requesting, provisioning, and managing infrastructure resources across clouds. vRA simplifies complex manual processes and accelerates the management and deployment of compute services and applications. It is important for vRA to perform and execute fast under different infrastructure configurations. For at least this reason, scale and performance load validation may be performed to ensure new maximum benchmark before each release.

Currently, vRA scale and performance load validation is performed using real vCenter endpoints. This is very expensive on acquiring and maintaining large endpoints. Secondly, setting up and configuring endpoints is time-consuming and this overhead slows down the testing process. Periodically, tests need to be performed based upon some complex customer settings in order to reproduce customer issue. However, because of resource limitation, such as number of ESXi hosts, storage capacity, and/or or network topology limitation, some validation cannot be performed under intended configuration.

vCenter Simulator (vCSIM) is a lightweight API-based vCenter simulator framework. vCenter, as known to those of skill in the art is a management system used to manage VCIs, hosts, and other virtual components. Where the term “management system” is used herein, it is to be understood that such usage may refer to an instance of a management system (e.g., a “vCenter”). vCSIM supports basic vCenter objects, such as data centers, clusters, hosts, data stores, storage clusters, networks, templates, volumes, and VCIs. Additionally, it can be deployed within a docker container. vCSIM can create a vCenter model endpoint with a datacenter, hosts, cluster, resource pools, networks, and/or a datastore.

Embodiments of the present disclosure can integrate vCSIM with vRA through vCenter adapter. Accordingly, vRA can recognize a vCSIM endpoint and a cloud account can be created for the vCSIM endpoint like other real vSphere cloud accounts in vRA. The modified vCenter adapter can collect resources defined in vCSIM simulator framework and then provision virtual machines with basic templates in the vCSIM framework.

Validation can be performed quickly with less setup and configuration overhead. Scale and performance load validation can be performed on different configurations without physical resource restriction. Validation can be performed quickly with less setup and configuration overhead. In addition, it is possible for other developers to use vCSIM endpoints to validate new feature implementation on large scale setup.

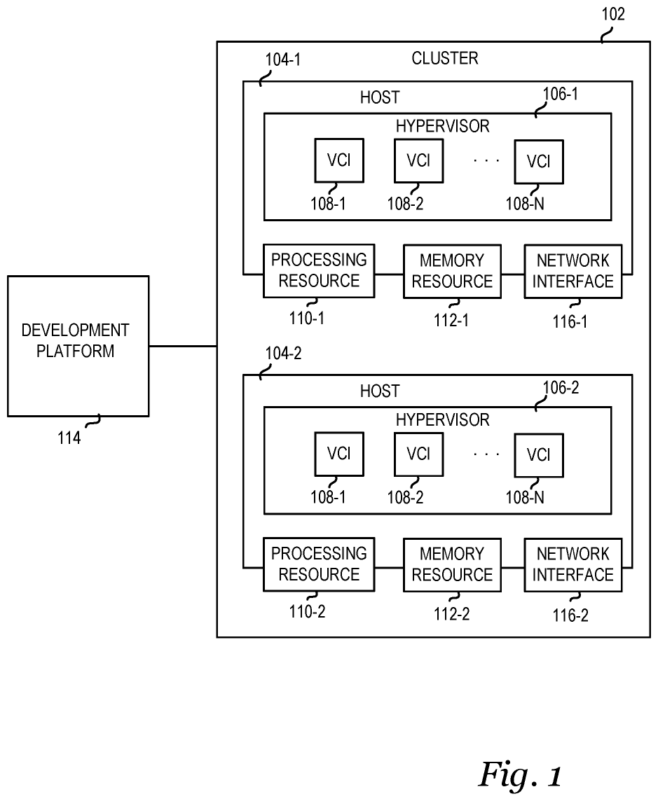

FIG. 1 is a diagram of a host and a system for development platform validation with simulation according to one or more embodiments of the present disclosure. The system can include a cluster 102 in communication with a development platform 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the development platform 114. In some embodiments, the development platform 114 can be deployed on a server, such as a web server.

The development platform 114 can include computing resources (e.g., processing resources and/or memory resources in the form of hardware, circuitry, and/or logic, etc.) to perform various operations, as described in more detail herein.

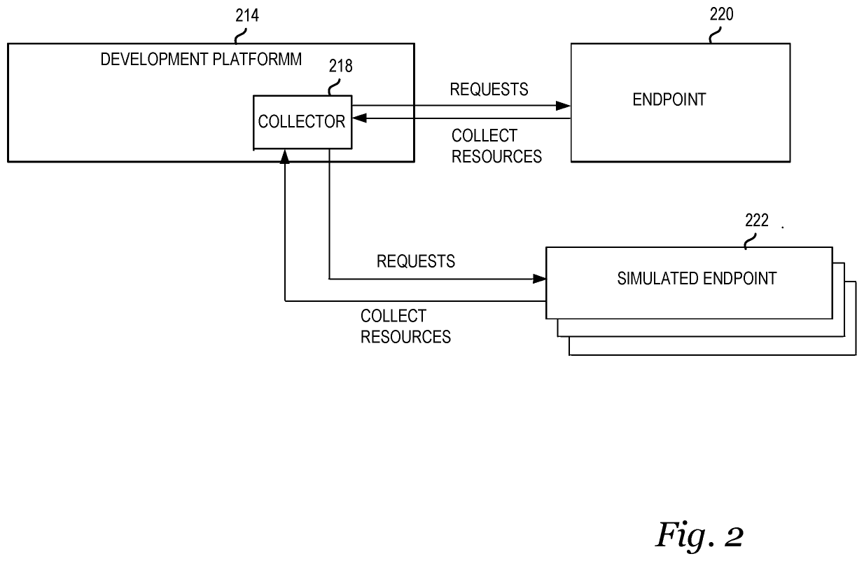

FIG. 2 illustrates a system for development platform validation with simulation according to one or more embodiments of the present disclosure. As shown in FIG. 2, the system includes a development platform (e.g., vRA) 214 in communication with an endpoint (e.g., real endpoint) 220. The endpoint 220 is a management system (e.g., vCenter server). More specifically, a collector (e.g., vCenter Adapter) 218 can monitor and collect data from the endpoint 220 (e.g., responsive to requests). Such data can include metrics produced by the endpoint 220 and/or properties of the resources included in the endpoint 220, for instance.

In accordance with the present disclosure, the system can include a simulated endpoint 222. The simulated endpoint 222 can be a vCSIM simulation of a management system. In some embodiments, the simulated endpoint 222 is deployed in a container. In some embodiments, the simulated endpoint 222 is deployed in a docker container. The collector 218 can monitor and collect data from the simulated endpoint 222 (e.g., responsive to requests). Such data can include simulated metrics produced by the simulated endpoint 222 and/or properties of the simulated resources included in the simulated endpoint 222, for instance.

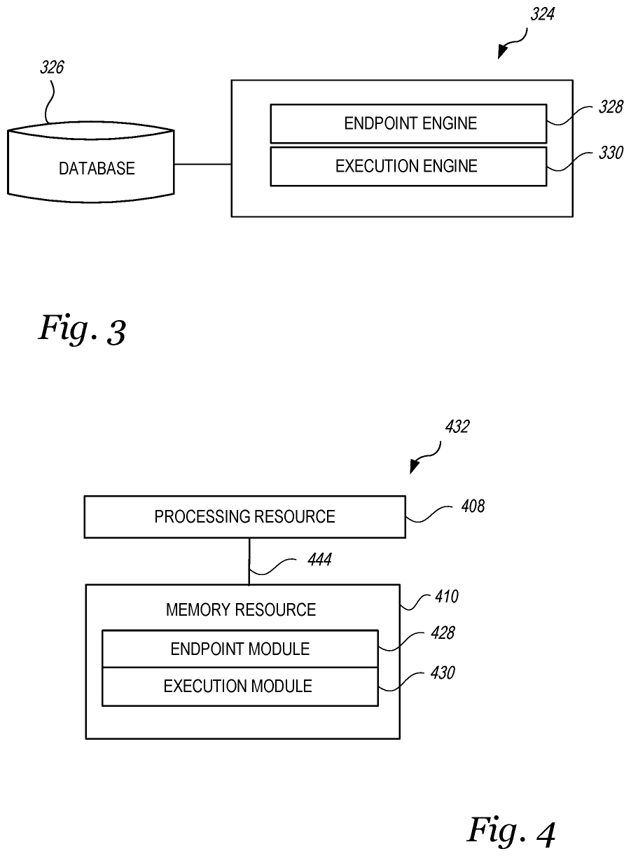

FIG. 3 is a diagram of a system 324 for development platform validation with simulation according to one or more embodiments of the present disclosure. The system 324 can include a database 326 and/or a number of engines, for example endpoint engine 328 and/or execution engine 330, and can be in communication with the database 326 via a communication link. The system 324 can include additional or fewer engines than illustrated to perform the various functions described herein. The system can represent program instructions and/or hardware of a machine (e.g., machine 432 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the endpoint engine 328 can include a combination of hardware and program instructions that is configured to recognize a simulation of a management system as an endpoint of a development platform in a virtualized environment. In some embodiments, the execution engine 330 can include a combination of hardware and program instructions that is configured to execute performance testing on the development platform using the simulation.

FIG. 4 is a diagram of a machine for development platform validation with simulation according to one or more embodiments of the present disclosure. The machine 432 can utilize software, hardware, firmware, and/or logic to perform a number of functions. The machine 432 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 442 (e.g., the machine 442 can include internal memory resources and have access to external memory resources). In some embodiments, the machine 442 can be a virtual computing instance (VCI). The program instructions (e.g., machine-readable instructions (MRI)) can include instructions stored on the MRM to implement a particular function (e.g., an action such as configuring a certificate, as described herein). The set of MRI can be executable by one or more of the processing resources 408. The memory resources 410 can be coupled to the machine 432 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 444. The communication path 444 can be local or remote to the machine 432. Examples of a local communication path 444 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 444 can be such that the memory resources 410 are remote from the processing resources 408, such as in a network connection between the memory resources 410 and the processing resources 408. That is, the communication path 444 can be a network connection. Examples of such a network connection can include a local area network (LAN), wide area network (WAN), personal area network (PAN), and the Internet, among others.

As shown in FIG. 4, the MM stored in the memory resources 410 can be segmented into a number of modules 428, 430 that when executed by the processing resources 408 can perform a number of functions. As used herein a module includes a set of instructions included to perform a particular task or action. The number of modules 428, 430 can be sub-modules of other modules. For example, the endpoint module 428 can be a sub-module of the execution module 430 and/or can be contained within a single module. Furthermore, the number of modules 428, 430 can comprise individual modules separate and distinct from one another. Examples are not limited to the specific modules 428, 430 illustrated in FIG. 4.

Each of the number of modules 428, 430 can include program instructions and/or a combination of hardware and program instructions that, when executed by a processing resource 408, can function as a corresponding engine as described with respect to FIG. 3. For example, the endpoint module 428 can include program instructions and/or a combination of hardware and program instructions that, when executed by a processing resource 408, can function as the endpoint engine 328, though embodiments of the present disclosure are not so limited.

The machine 432 can include an endpoint module 428, which can include instructions to recognize a simulation of a management system as an endpoint of a development platform in a virtualized environment. The machine 432 can include an execution module 430, which can include instructions to execute performance testing on the development platform using the simulation.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
recognize a simulation of a management system as an endpoint of a development platform in a virtualized environment; and
execute performance testing on the development platform using the simulation.

2. The medium of claim 1, including instructions to provision a simulated virtual computing instance (VCI) of the simulated management system.

3. The medium of claim 1, wherein the instructions to execute performance testing on the development platform using the simulation include instructions to execute scale testing and load testing on the development platform.

4. The medium of claim 1, including instructions to validate a new feature of the development platform using the simulation.

5. The medium of claim 1, wherein the simulation of the management system includes simulations of:
data centers;
clusters;
hosts;
data stores;
storage clusters;
networks; and
virtual computing instances (VCIs).

6. The medium of claim 1, wherein the simulation of the management system is deployed within a docker container.

7. The medium of claim 1, including instructions to create a cloud account for the simulation of the management system.

8. A method, comprising:
recognizing a simulation of a management system as an endpoint of a development platform in a virtualized environment; and
executing performance testing on the development platform using the simulation.

9. The method of claim 8, wherein the method includes provisioning a simulated virtual computing instance (VCI) of the simulated management system.

10. The method of claim 8, wherein executing performance testing on the development platform using the simulation includes executing scale testing and load testing on the development platform.

11. The method of claim 8, wherein the method includes validating a new feature of the development platform using the simulation.

12. The method of claim 8, wherein the simulation of the management system includes simulations of:
data centers;
clusters;
hosts;
data stores;
storage clusters;
networks; and
virtual computing instances (VCIs).

13. The method of claim 8, wherein the method includes deploying the simulation of the management system within a docker container.

14. The method of claim 8, wherein the method includes creating a cloud account for the simulation of the management system.

15. A system, comprising:
an endpoint engine configured to recognize a simulation of a management system as an endpoint of a development platform in a virtualized environment; and
an execution engine configured to execute performance testing on the development platform using the simulation.

16. The system of claim 15, wherein the endpoint engine is configured to provision a simulated virtual computing instance (VCI) of the simulated management system.

17. The system of claim 15, wherein the execution engine is configured to execute scale testing and load testing on the development platform.

18. The system of claim 15, wherein the execution engine is configured to validate a new feature of the development platform using the simulation.

19. The system of claim 15, wherein the simulation of the management system includes simulations of:
data centers;
clusters;
hosts;
data stores;
storage clusters;
networks; and
virtual computing instances (VCIs).

20. The system of claim 15, wherein the simulation of the management system is deployed within a docker container.
